(19) United States
(12) Patent Application Publication
(10) Pub. No.: US 2025/0171645 A1
(43) Pub. Date: May 29, 2025

(54) USE OF A HYDROPHOBIC POLYMER ON DECORATIVE PANELS AND METHOD

(71) Applicant: UNILIN, BV, Wielsbeke (BE)

(72) Inventors: Martin SEGAERT, Wielsbeke (BE); Raul PRIETO, Senden (DE)

(21) Appl. No.: 18/842,465

(22) PCT Filed: Mar. 7, 2023
(86) PCT No.: PCT/IB2023/052147

§ 371 Date: Aug. 29, 2024

(30) Foreign Application Priority Data
Mar. 8, 2022 (EP) 22160943.1
Mar. 15, 2022 (BE) 2022/5176
Apr. 5, 2022 (BE) 2022/5261
Jun. 10, 2022 (BE) 2022/5449
Jan. 4, 2023 (BE) 2023/5002

(51) Int. Cl. C09D 5/16; C09D 7/20; C09D 7/63; C09D 7/65; C09D 167/06; C09D 175/06; E04F 15/04

(52) U.S. Cl. CPC C09D 5/1637; C09D 7/20; C09D 7/63; C09D 7/65; C09D 167/06; C09D 175/06; E04F 15/041; E04F 2201/023; E04F 2201/042; E04F 2201/043

(57) ABSTRACT

The use of a hydrophobic polymer, being for example a hydrophobic polyurethane or a hydrophobic acrylate polymer, is for producing a coating or treatment on one or more surfaces of decorative panel. The hydrophobic polymer includes an aliphatic hydrocarbon group, preferably with between 6 and 34 carbon atoms. The use may be provided in a method for the manufacture of decorative panels, decorative panels and as a mixture.

The present invention relates to the use of a hydrophobic polymer on decorative panels, as well as to a method for the manufacture of decorative panels, such as floor panels, wherein said hydrophobic polymer is used and decorative panels, such as floor panels, comprising a hydrophobic polymer of this kind, and the present invention also relates to a mixture comprising a hydrophobic polymer of this kind.

In particular, the invention relates to panels that are used for the assembly of for example a floating floor covering. Floor panels of this kind are known from WO 97/47834 and may be provided on two opposite lateral edges with profiled edge regions that comprise milled coupling means fitting into each other, with which two such floor panels may be coupled together on the respective lateral edges, preferably without using glue. Optionally, the coupling means may be configured with some pretension, which means that the contour of the coupling means is configured to be somewhat overlapping, in such a way that in the coupled state a tension arises that presses the panels toward each other. Said pretension is advantageous to counteract the formation of gaps after laying. As a result, penetration of dust and moisture may also be limited. In some cases the quality of milling of the coupling means is inadequate for keeping the seams permanently waterproof. Moreover, at the location of the corner points of such panels there is increased susceptibility to water penetration. At the location of the corners, the profiled edge regions of adjacent lateral edges cross, and therefore it is possible that the milled coupling means may be absent or inadequate there.

The penetration of moisture in the seams of a floor covering that has been assembled from panels may in the case of panels with a moisture-sensitive substrate and/or top layer, such as a substrate based on MDF or HDF (medium or high density fiberboard), lead to swelling and/or discoloration that becomes annoyingly visible on the decorative surface of said panels. In addition, said swelling of the substrate may lead per se to accelerated wear of the floor surface. Furthermore, penetration of moisture in the seams of a floor covering is problematic per se, even if neither the substrate nor the top layer is moisture-sensitive. In such a case water may collect underneath the floor covering and this may give rise to mold formation.

From WO 2008/078181 it is known for the lateral edges of a floor panel with an MDF or HDF substrate to be treated with a water-repellent substance that comprises a fluorinated polymer or copolymer. The substance in question is applied on the lateral edge of the floor panel by means of a so-called Vacuumat, for example of the type as known from DE 92 02 976 U1. Starting and stopping of said Vacuumat respectively at entry of the lateral edge and exit of the lateral edge from the Vacuumat is difficult to adjust finely, and means that the corner points of the respective lateral edge are possibly inadequately covered with the water-repellent substance in question. In addition, fluorocarbon compounds are persistent chemicals, both in the environment and in the human body. It is therefore desirable to restrict the use of fluorocarbon compounds.

The present invention also relates in particular to floor panels comprising a substrate and a decorative top layer, wherein this decorative top layer comprises a layer of wood, being for example a veneer, when the layer of wood is thinner than 2.5 mm, or being a layer of wood thicker than 2.5 mm, in which case it is called parquet.

The present invention aims firstly to offer an alternative for forming a water-resistant or water-repellent coating on decorative panels, wherein according to various preferred embodiments a solution may be offered for one or more of the problems with the methods and/or panels from the prior art.

The invention is among other things defined in the appended claims and relates among other things to the use of a hydrophobic polymer, and to a method wherein said hydrophobic polymer is applied on panels, also to panels comprising a hydrophobic polymer of this kind and to a mixture comprising a hydrophobic polymer of this kind.

A first aspect of the invention relates to the use of a hydrophobic polymer, being for example a hydrophobic polycarbodiimide, a hydrophobic polyurethane or a hydrophobic acrylate polymer, for realizing a coating or treatment on one or more surfaces of decorative panels, wherein the hydrophobic polymer comprises an aliphatic hydrocarbon group, preferably with between 6 and 34 carbon atoms. It is possible to use one type of hydrophobic polymers comprising at least one, two or more aliphatic hydrocarbon groups, wherein these aliphatic hydrocarbon groups preferably comprise between 6 and 34 carbon atoms. Thus, it is possible for example to use only a hydrophobic polycarbodiimide with at least one, two or more aliphatic hydrocarbon groups. It is also possible to use several types of hydrophobic polymers, for example mixtures comprising hydrophobic polycarbodiimides and hydrophobic acrylate polymers.

A hydrocarbon group may also be indicated with the term ‘hydrocarbon group’ An aliphatic hydrocarbon group indicates a nonaromatic hydrocarbon group. Preferably, a hydrocarbon group indicates a group with exclusively hydrogen (H) and carbon (C). However, halogenated hydrocarbon groups, with for example one, two or more fluorine atoms, are also possible.

The use preferably comprises one or more of the following characteristic features, wherein two or more features are combined, so long as these are not incompatible with each other:
the aliphatic hydrocarbon group is a linear hydrocarbon chain,
the aliphatic hydrocarbon group is a branched hydrocarbon chain;
the aliphatic hydrocarbon group is a cyclo-aliphatic hydrocarbon group (alicyclic hydrocarbon group);
the hydrophobic polymer comprises one said aliphatic hydrocarbon group preferably with between 6 and 34 carbon atoms;
said aliphatic hydrocarbon group comprises at least 4 carbon atoms, preferably at least 12 carbon atoms, even more preferably at least 16 carbon atoms;
the hydrophobic polymer is built up from monomers comprising at least one said aliphatic hydrocarbon group and preferably comprising at least two said aliphatic hydrocarbon groups;
the hydrophobic polymer is built up exclusively from monomers comprising at least one said aliphatic hydrocarbon group and preferably comprising at least two said aliphatic hydrocarbon groups;
the hydrophobic polymer is a homopolymer or a copolymer;
the hydrophobic polymer comprises two or more said aliphatic hydrocarbon groups, wherein these aliphatic hydrocarbon groups are all the same or these aliphatic hydrocarbon groups comprise two or more different aliphatic hydrocarbon groups, whether or not of different types, being for example the types of aliphatic linear hydrocarbon chains, branched hydrocarbon chains and cyclo-aliphatic hydrocarbon groups, wherein preferably at least one of these aliphatic hydrocarbon groups comprises between 6 and 34 carbon atoms;
the aliphatic hydrocarbon group comprises between 6 and 34 carbon atoms. Preferably the hydrocarbon group comprises at least 8 carbon atoms, even more preferably at least 10 carbon atoms, and most preferably at least 12 carbon atoms. Also preferably, the hydrocarbon group comprises at most 30 carbon atoms, even more preferably at most 28 carbon atoms, and most preferably at most 26 carbon atoms. Thus, the hydrocarbon group may comprise for example 12 carbon atoms, 16 carbon atoms, for example a hexadecyl group (C₁₆H₃₃), 18 carbon atoms, for example an octadecyl group (C₁₈H₇), or 22 carbon atoms;
the hydrophobic polymer is selected from the group comprising: a hydrophobic polyurethane, a hydrophobic acrylate, a hydrophobic vinyl acetate, a hydrophobic alkyd, a hydrophobic methacrylate, a hydrophobic polyester resin, a hydrophobic hybrid alkyd-acrylic resin, a hydrophobic hybrid polyurethane-acrylic resin, a long oil low-viscosity alkyd resin based on drying vegetable fatty acids, a hydrophobic polycarbodiimide or a hydrophobic polyvinyl alcohol;
the hydrophobic polymer is a hydrophobic polymer consisting of 3 to 10 units,
the aliphatic hydrocarbon group forms part of an acrylate group or a methacrylate group; the hydrophobic polymer is a hydrophobic polyurethane comprising between 2 and 12 acrylate groups and/or methacrylate groups, wherein these acrylate groups and/or methacrylate groups each comprise aliphatic hydrocarbon groups, which are or are not different from each other and preferably with between 2 and 34 carbon atoms, wherein preferably at least one of these aliphatic hydrocarbon groups comprises at least 8 carbon atoms;
the hydrophobic polymer is free from fluorine atoms. Preferably, the hydrophobic polymer forms part of a mixture that is completely free from fluorine atoms. Embodiments wherein the mixture comprises a limited amount of fluorine, being for example less than 1 percent by weight (1 wt %) of fluorine, preferably less than 0.5 wt %, even more preferably less than 0.1 wt % or even less than 0.01 wt %, are also possible Fluorine may be in the form of organic or inorganic fluorine-containing compounds;
the hydrophobic polymer is a silicon-containing compound, such as a siloxane, a silicone or a silane, such as an organosilane, for example a silane comprising for example a hexadecyl group and/or an alkoxysilane;
a said hydrophobic polycarbodiimide is derived from a carbodiimidization reaction (being a reaction that forms (N═C═N) groups) of a carbodiimidization reaction mixture that comprises at least one oligomer, wherein said oligomer comprises at least one (usually one) isocyanate end group and at least two repeating units, wherein each of the at least two repeating units has at least one (typically one) hydrocarbon group that comprises at least 4 carbon atoms (and in certain embodiments up to 60 carbon atoms or up to 30 carbon atoms);
a said hydrophobic polycarbodiimide is derived from a carbodiimidization reaction of a carbodiimidization reaction mixture comprising 4,4′-methylenebis(phenylisocyanate) and an acrylate oligomer in a molar ratio from 2:1 to 10:1, the acrylate oligomer prepared by reaction of an oligomerization reaction mixture that contains mercaptoethanol and octadecyl acrylate in a molar ratio from 1:4 to 1:20, or an oligomerization reaction mixture that comprises mercaptoethanol and a reaction product of octadecyl isocyanate with 2-hydroxyethyl(meth)acrylate or octadecyl isocyanate with 2-isocyanatoethyl(meth)acrylate, wherein the mercaptoethanol and the reaction product are converted in a molar ratio from 1:4 to 1:20;
a said hydrophobic polycarbodiimide is derived from dehydrodesulfurization of ureas, such as thioureas;
a said hydrophobic polycarbodiimide is derived from a carbodiimidization reaction of isocyanates.

Here, “oligomers” preferably means compounds with at least 2 and up to 20 repeating units. According to a certain embodiment, the oligomer has 3 to 15 repeating units. According to another embodiment, the oligomer has 4 to 15 repeating units in certain embodiments an oligomer has an average molecular weight up to 50 000 g/mol. These oligomers may also be called polymers, for example short polymers.

It is possible to use one type of hydrophobic polymer with an aliphatic hydrocarbon group with between 6 and 34 carbon atoms. However, it is also possible to use two or more types of hydrophobic polymers each with at least one aliphatic hydrocarbon group with between 6 and 34 carbon atoms. Thus, it may for example be selected from a combination of two or more of the following hydrophobic polymers: hydrophobic polyurethanes, hydrophobic acrylates, hydrophobic vinyl acetates, hydrophobic alkyd, hydrophobic silicon-containing compounds, a hydrophobic methacrylate, a hydrophobic polyester resin, a hydrophobic hybrid alkyd-acrylic resin, hydrophobic polycarbodiimides or a hydrophobic hybrid polyurethane-acrylic resin. It is also possible to use two or more hydrophobic polymers of the same type, but that differ from each other. Thus, it is possible to use hydrophobic polyurethanes comprising different hydrocarbon groups.

The aforesaid aliphatic hydrocarbon group or aliphatic hydrocarbon groups of the hydrophobic polymer will, after the hydrophobic polymer has been applied on a decorative panel, preferably be directed away from the panel, for example be directed outwards, and thus ensure water-repellent/water-resistant properties of the decorative panel. The more carbon atoms the aliphatic hydrocarbon group comprises, the greater are the water-repellent properties. These hydrophobic polymers ensure that water cannot pass through the seams between panels and/or they ensure that water cannot penetrate into porous components of the panel. The water-repellent/water-resistant properties are obtained without the need for fluorine atoms. These aliphatic hydrocarbon groups do not have any negative effect on the environment and human health. Thus, they are not persistent in the environment and do not give rise to bioaccumulation. Hydrophobic polymers comprising one or more aliphatic hydrocarbon groups with 8, 12, 16, 18 or 22 carbon atoms have good moldability. The hydrophobic polymer can bond directly or indirectly to a decorative panel, for example with the edges or some other surface of the decorative panel.

In a specific embodiment, a said aliphatic hydrocarbon group is a linear aliphatic hydrocarbon chain preferably with the formula CₙH₂ₙ₊₁ where n is between 6 and 34. These linear hydrocarbon chains are always directed linearly away from the decorative panel and so are very well able to repel water, without several aliphatic hydrocarbon chains for example causing steric hindrance to each other. In this way, the quantity of hydrophobic polymers that is used to attain the necessary water resistance/water repellency may be limited. In a specific embodiment, the hydrophobic polymer comprises two or more said linear aliphatic hydrocarbon chains, wherein these linear aliphatic hydrocarbon chains are or are not different.

In a specific embodiment, the use is at least for realizing a coating or treatment on the lateral edges of decorative panels. The penetration of moisture, such as water and/or liquid cleaning products in the seams between decorative panels, for example in the seams of a floor covering, is a frequently occurring problem. Water that penetrates into these seams may cause mold formation underneath the panels. When the floor panels comprise a moisture-absorbing substrate, such as MDF or HDF, and/or a moisture-absorbing top layer, for example a top layer comprising a layer of wood, such as a veneer or a thicker layer of wood, this water may also penetrate into this moisture-absorbing substrate and/or top layer and cause swelling and/or discoloration. By treating the edges with the aforesaid hydrophobic polymer, this problem is solved. The use according to the present invention is for example applied as treatment of MDF or HDF (medium or high density fiberboard) edges of laminate floor panels, for example for obtaining a water-repellent or water-resistant effect, wherein the hydrophobic polymer is bonded directly or indirectly on the MDF or HDF. The use according to the invention may also be applied as treatment of magnesium oxide (MgO) or other mineral-based edges of floor panels comprising an MgO or other mineral-based substrate, wherein the hydrophobic polymer is bonded directly or indirectly on the substrate Examples of other mineral-based substrates are for example gypsum-based substrates, cement-based substrates, etc. The use according to the invention may also be applied as treatment of thermoplastic-based edges of floor panels, such as at the edges of polyvinyl-based floor panels or other thermoplastic floor panels, such as SPC and LVT floor panels, wherein this use in particular stops penetration at the level of the edges so as to prevent mold formation on the underside of the floor panels. Here, the hydrophobic polymer will be bonded directly or indirectly on the thermoplastic-based edges. Examples of non-vinyl-based thermoplastics that are usable in floor panels are for example polyethylene (PE), polypropylene (PP) or polylactic acid (PLA). The thermoplastic may also be polyvinyl butyral (PVB).

In another embodiment, the use is for realizing a coating or treatment on at least the top surface of a layer of wood, such as a veneer or a thicker layer of wood. This contributes to better water resistance of the layer of wood and/or less adherence of dirt on the layer of wood, for example in the wood grain. After this use, this layer of wood may then be treated additionally with an oil or a resin. Thus, one or more additional oil layers or resin layers may then be applied on the layer of wood. In an alternative embodiment, first one or more oil layers or resin layers may be applied on the layer of wood, after which this layer of wood is treated with the aforesaid hydrophobic polymer. This layer of wood then preferably forms part of the decorative top layer of a veneer parquet or a parquet floor panel, wherein this layer of wood is then for example fastened on a substrate and this floor panel may or may not additionally comprise a balance layer.

In a much preferred embodiment, the hydrophobic polymer is free from fluorine atoms. Here, no fluorocarbon groups are then present.

In a specific embodiment, a said hydrophobic polymer is a polycarbodiimide preferably with the following formula:

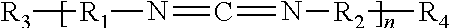

wherein at least one of the groups R₃ or R₄ comprises a said aliphatic carbon group and wherein preferably R₃ and R₄ comprise said aliphatic hydrocarbon groups, wherein R₃ and R₄ are or are not identical, and wherein n is an integer of at least 2, wherein preferably n is between 3 and 15, even more preferably between 3 and 10, and wherein R₁ and R₂ are residual groups derived from the carbodiimidization reaction, for example residual groups of isocyanates, such as methylene diphenyl diisocyanates.

R₁ and/or R₂ may for example have the following formula:

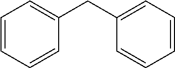 [SMILES: c1ccc(Cc2ccccc2)cc1]

Moreover, in a specific embodiment R₃ and/or R₄ have the following formula:

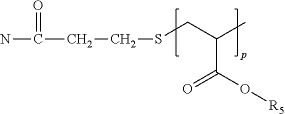

wherein p is an integer of at least 1, wherein preferably p is between 2 and 15, even more preferably between 3 and 10 and wherein R₅ is a said aliphatic hydrocarbon group. R₅ may for example be a linear hydrocarbon group with 12, 14, 16 or 18 carbon atoms. Thus, the hydrophobic polymer may for example comprise an oligomer of acrylates, such as octadecyl acrylates.

The polycarbodiimide may thus for example have the following formula:

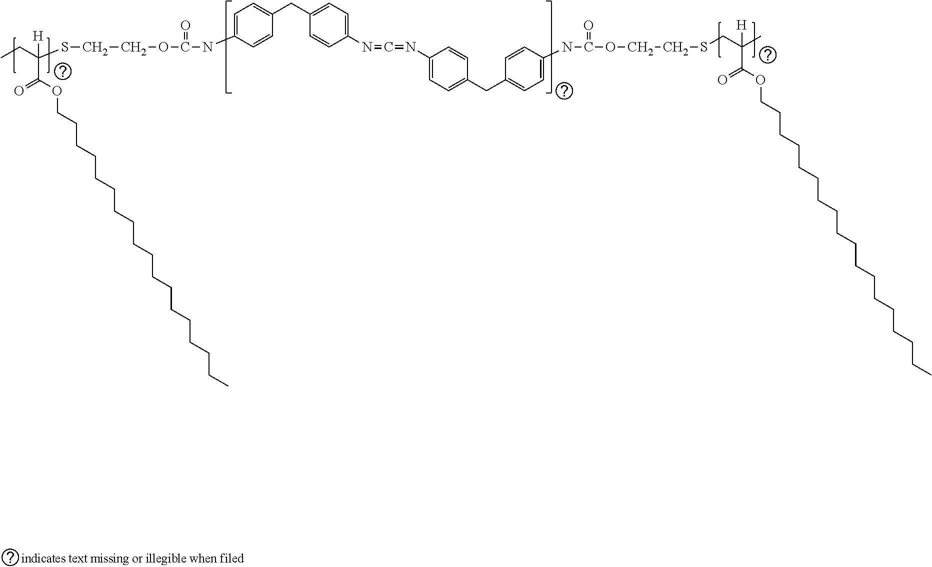

wherein m, n and p are each integers of at least 1, preferably between 2 and 15, even more preferably between 3 and 10, and wherein m, n and p are or are not identical to each other.

In a very specific embodiment, the hydrophobic polymer is a hydrophobic polyurethane preferably with the following formula:

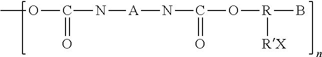

as well as preferably one or more of the following characteristics:
n is between 3 and 15, even more preferably between 3 and 10;
A is a residue of an isocyanate, for example a residue of a diisocyanate, such as methylene diphenyl diisocyanate, or of a triisocyanate or of a polyisocyanate. This polyisocyanate may for example be a reaction product of carbodiimide and an isocyanate;
R is a hydrocarbon group;
R′ is a hydrocarbon group, such as an alkene group;
X is a heteroatom or a hydrogen;
B comprises said aliphatic hydrocarbon group.

It was found, surprisingly, that hydrophobic polyurethanes are very suitable for providing decorative panels, such as floor panels, with the necessary water-resistant/water-repellent properties. Hydrophobic polyurethanes of this kind may also easily be applied on decorative panels, for example by dissolving these hydrophobic polyurethanes in one or more solvents and optionally cosolvents. Very good results are obtained with polyurethanes with the aforementioned formula.

R may for example have one of the following formulas.

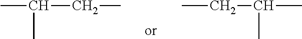

R′ may for example be a methylene group, an ethylene group, a propylene group or a butylene group.

X may for example be an oxygen atom (O), a nitrogen group (NH) or a sulfur (S).

B may for example comprise the following formula

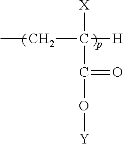

with X being CH₂, H, an acrylate or a methacrylate;
with p between for example 2 and 12;
with Y being a said aliphatic hydrocarbon group, such as a linear aliphatic hydrocarbon chain with between 6 and 34 carbon atoms, for example 12, 16, 18 or 22 carbon atoms.

In another embodiment, the hydrophobic polymer is a hydrophobic acrylate polymer or a hydrophobic methacrylate polymer with the following formula.

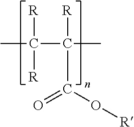

wherein the R groups are hydrocarbon groups or hydrogen atoms and the R′ group is a said aliphatic hydrocarbon group.

It is also possible that several types of hydrophobic polymers, for example a mixture of hydrophobic polyurethanes and/or hydrophobic acrylate polymers and/or hydrophobic polycarbodiimide, are used for realizing the aforementioned coating or treatment.

In a preferred embodiment, the hydrophobic polymer forms part of a mixture that, besides the aforesaid hydrophobic polymer, comprises silicon-containing compounds, wherein these silicon-containing compounds are preferably selected from the group: siloxanes, silicones, (organofunctional) silanes, SiO₂-containing compounds, silylated polyurethane resins and (poly)silazanes. Here, said mixture then comprises for example a non-silicon-containing hydrophobic polymer, such as a hydrophobic polyurethane, a hydrophobic acrylate, a hydrophobic vinyl acetate, a hydrophobic alkyd, a hydrophobic methacrylate, a hydrophobic polyester resin, a hydrophobic hybrid alkyd-acrylic resin, a hydrophobic polycarbodiimide or a hydrophobic hybrid polyurethane-acrylic resin, and additionally a silicon-containing compound, wherein this silicon-containing compound preferably is also hydrophobic. This silicon-containing compound is for example hydrophobic because this compound also comprises a said aliphatic hydrocarbon group with between 6 and 34 carbon atoms. Said silicon-containing compound may also be regarded as an additional hydrophobic polymer according to the first aspect of the invention A hydrophobic silicon-containing compound not only contributes to the water repellency/water resistance, but also provides the necessary soap resistance A decorative panel treated with said mixture will then not only repel water, but will also be resistant to soaps. This means that this decorative panel can be cleaned with a solution of soap in water without damaging the decorative panel. The silicon-containing compounds are for example bifunctional or trifunctional silicones. These silicon-containing compounds are very well able to bond with wood or wood-based materials, for example with MDF, HDF, veneer, etc. These silicon-containing compounds may also be organofunctional silanes, for example such as a hexadecyl trimethoxysilane or a hexadecyl triethoxysilane or an octadecyl triethoxysilane. The silanes may also be oligomers of the methoxylated type (methoxysilanes) or oligomers with ethoxy functional groups (ethoxysilanes). Very good results are obtained when the hydrophobic polymer forms part of a mixture comprising a hydrophobic polyurethane and an organofunctional silane, such as hexadecyl trimethoxysilane, wherein the silane for example accounts for between 5 and 15 wt % of the mixture, for example accounts for 10 wt % of the mixture. Silylated polyurethane resins and/or (poly)silazanes may contribute to soap resistance. Thus, the mixture may for example comprise between 0.5 and 1.5 wt % cyclosilazane. The mixture may for example comprise 3-aminopropyltriethoxysilane, for example between 0.5 and 1.5 wt % of 3-aminopropyltriethoxysilane.

More preferably this mixture may comprise components that help to prevent unwanted hydrolysis of the silicon-containing compounds, such as an oxazolidine or polyacrylates. Thus, the mixture may for example comprise between 0.5 and 2 wt % oxazolidine.

In an alternative embodiment, the hydrophobic polymer is a silicon-containing compound and the hydrophobic polymer does not form part of a mixture that further comprises additional non-silicon-containing hydrophobic polymers with a said aliphatic hydrocarbon group.

In a specific embodiment, one or more of said silicon-containing compounds and a said hydrophobic polymer are bound together covalently. This contributes to very good water repellency and soap resistance. Certain silicon-containing compounds may also only be bonded to the decorative panel. When a said hydrophobic polymer is bound covalently with a said silicon-containing compound, the hydrophobic polymer may then be bonded indirectly to a decorative panel, via the silicon-containing compound. This contributes to the soap resistance, and the aliphatic hydrocarbon group is then well able to repel water from the decorative panel, because it is located at a sufficient distance from the decorative panel.

In a preferred embodiment, the hydrophobic polymer forms part of a mixture that, besides said hydrophobic polymer, comprises paraffin, for example a paraffin wax. Preferably the paraffin wax has a melting point from 40° C. to 75° C. Even more preferably, the paraffin wax has a melting point from 60° C. to 75° C. The mass ratio/weight ratio of paraffin to the hydrophobic polymer, for example to the hydrophobic polycarbodiimide, is preferably 1.99 to 7.3, for example 1:50 to 1:10 or 1:30 to 1:20.

In a specific embodiment, the hydrophobic polymer forms part of a mixture that comprises a polytetrafluorethylene wax.

The hydrophobic polymer and the paraffin in the mixture preferably account for 1 to 20 wt % of the total weight of the mixture. Suitable polycarbodiimide compounds and paraffin waxes and their preparation are described for example in U.S. Pat. No. 11,124,918 B2.

In an especially preferred embodiment, the hydrophobic polymer forms part of a mixture that, besides said hydrophobic polymer, comprises at least one polymer selected from alkyd resins, acrylate resins, polyurethane modified polyesters, silanes, siloxanes or mixtures thereof. The proportion of this polymer is preferably 5 to 40 wt % based on the total weight of the mixture. The polymers may bear anionic groups, for example sulfonic acid groups.

Alkyd resins may for example be long oil or medium-long oil alkyd resin. Long oil alkyd resins are alkyd resins with a fatty acid content of more than 60%; medium-long oil alkyds comprise 40 to 60% fatty acids. Suitable fatty acids are for example vegetable fatty acids. The acid number is preferably below 20 mg KOH/g; the iodine number is preferably below 20. The alkyd resins may or may not be urethane or isocyanate modified to promote water resistance. The advantage is threefold: besides the price advantage, the alkyd not only provides increased viscosity, but especially in the case of a medium-long or long chain resin it penetrates less deeply into the wood and may, owing to its low dispersion, form a first barrier. The resin forms an outermost film. Since a relatively thin layer is applied, the coating does not need to be dried to meet the existing environmental standards.

Acrylate resins may comprise pure acrylates or styrene acrylates. Examples of suitable monomers are methyl methacrylate, styrene, acrylonitrile, butyl methacrylate, ethyl acrylate, butyl acrylate or ethylhexyl acrylate. In addition, monomers such as methacrylic acid, glycidyl methacrylate, 3-(trimethoxysilyl)propylmethacrylate, acetoacetoxyethyl methacrylate, acrylic acid, itaconic acid or diacetone acrylamide may be used.

Examples of polyurethane modified polyesters are branched, unsaturated, aromatic or aliphatic polymers. They have an average molecular weight between 1000 and 20000 g/mol. The content of free OH groups is preferably 0.5 to 5 wt % of the total weight of the polyester.

Silanes may have 1 to 10 carbon atoms, preferably 2 to 6 carbon atoms. They may comprise amino, alkyl and/or alkoxy groups with 1 to 10 carbon atoms, preferably 1 to 6 carbon atoms.

Siloxanes comprise for example polysiloxanes, wherein the siloxane monomer unit has 1 to 12 carbon atoms. They may bear alkyl, alkenyl, such as vinyl, aryl, such as phenyl, amino, alkoxy or H groups in the side groups. The alkyl groups are preferred, wherein methyl (polydimethylsiloxanes, PDMS), methoxy or ethoxy groups are particularly preferred.

The aforementioned polymers may be used in particular in the form of solutions or dispersions. In a much preferred embodiment, paraffin, such as paraffin wax, is also present in the mixture and preferably the mass ratio of (hydrophobic polymer, such as polycarbodiimide, +paraffin) to (the aforementioned polymer selected from alkyd resins, acrylate resins, polyurethane modified polyesters, silanes, siloxanes or mixtures thereof) is 10:90 to 90.10, preferably 70:30 to 95:5.

Preferably, the hydrophobic polymer forms part of a solvent-based mixture, or alternatively a water-based mixture. When the hydrophobic polymer is used for a veneer parquet or a veneer, the hydrophobic polymer then for example forms part of a water-based mixture. Because the hydrophobic polymer forms part of an aforementioned mixture, application of the hydrophobic polymer on the intended surface proceeds well. Thus, a solvent for example allows a certain degree of penetration. The hydrophobic polymer preferably accounts for at most 50 wt %, even more preferably at most 40 wt % and most preferably at most 30 wt % of the mixture. This mixture is then applied on the decorative panel. Thus, the hydrophobic polymer, being for example hydrophobic polyurethane, for example accounts for between 3 and 30 wt % of the mixture. The solvent may comprise for example alcohols and/or isoparaffinic liquids.

Moreover, the aforementioned solvent-based mixture preferably has a flash point of 35° C. or more, preferably of 55° C. or more.

The aforementioned solvent-based mixture comprises for example alkanes, such as iso-alkanes or branched alkanes or aliphatic hydrocarbons. The alkanes preferably have 10 to 20 carbon atoms. In order to increase the flash point, use may be made of 3-methoxy-3-methyl-1-butanol acetate. Thus, the mixture may for example comprise between 8 and 12 wt % of 3-methoxy-3-methyl-1-butanol acetate.

The aforementioned solvent-based mixture comprises for example one or more of the following components: ethylhexyl acetate, propyl acetate or butyl acetate—for example 3-Methoxy-3-Methyl-1-ButylAcetate (MMB-AC) or 1-MethoxyPropyl Acetate (MPA)-, triethyl citrate, propylene glycol methyl ether, propylene glycol methyl ether acetate, dibasic ester, glycol diether, benzoate ester, dipropylene glycol dimethyl ether or a tetramethoxy ether. These components may or may not be indicated as cosolvents.

The solvent-based mixture may optionally comprise additional additives. The solvent and the additives may for example be exclusively of the aliphatic type, or the proportion of solvent and additive of the aromatic type in the mixture is less than 1000 ppm, or less than 100 ppm.

Preferably, the optional mixture in which the hydrophobic polymer is contained is free from ethyl acetate. Ethyl acetate is highly flammable (flash point −3° C.), which results in a safety risk.

Preferably there are no flammable solvents present in the mixture that the hydrophobic polymer comprises. This factor has a strong impact on tire safety. If the solvents preferably have a flash point above 55° C., they can no longer be regarded as highly flammable or even flammable. The solvents, preferably at least iso-alkanes, remain flammable, however.

Preferably, during use, it is ensured that the LEL (lower explosion level) concentration is not reached. This is achieved with extraction in the application zone with a sufficient flow rate.

A so-called “cosolvent”, such as a glycol ether, a 2-ethylhexyl acetate, a methoxypropyl acetate or a triethyl citrate, may be present in the mixture. In the case of wood or of wood-based substrates, a so-called cosolvent serves as a wetting agent for the hydrophobic polymer, so that this hydrophobic polymer can penetrate deeper into for example wood fiberboard, that is to say MDF or HDF, and for example is taken up by wood more easily. The cosolvent may also ensure improved solubility.

A wetting agent such as a long-chain alcohol or 3,5-dimethyl-1-hexyn-3-ol may additionally be present in the mixture. One problem is that the affinity for MDF or HDF is usually low, because most MDFs and HDFs comprise for example paraffin waxes or oil-based emulsions, such as emulsions based on palm oil. Good spreading of the hydrophobic polymer is necessary, however, since surface defects may give rise to infiltration. A wetting agent may be added both to water-based but also to solvent-based mixtures comprising hydrophobic polymers, for better spreading of the hydrophobic polymers on the surface and/or to facilitate impregnation. The advantage of 3,5-dimethyl-1-hexyn-3-ol relative to a long-chain alcohol is that 3,5-dimethyl-1-hexyn-3-ol evaporates rapidly after application of the mixture, so that no additional water sensitivity is created.

The solvents based on iso-alkanes and glycols, which are possibly present in the mixture, are preferably nontoxic and consist of aliphatic compounds. It is best to ensure that the limits imposed by law are not exceeded. Owing to the low evaporation value, the risk is almost nonexistent.

Preferably, the hydrophobic polymer forms part of a water-based mixture. Water as solvent and/or a water-based mixture are advantageous because they are particularly environmentally friendly. Hydrophilic organic solvents that are miscible with water, such as alcohols, are especially suitable for water-based mixtures. The amount of solvent is preferably 20 to 95 wt % of the total weight of the mixture. Water-based mixtures preferably comprise acrylate resins and/or polyurethane modified polyesters and/or silanes and/or siloxanes. Water-based mixtures may or may not comprise cosolvents.

Preferably, the hydrophobic polymer forms part of a water-based mixture or a solvent-based mixture that is free from or low in volatile organic compounds (VOC-free mixture or low-VOC mixture). The water-based mixture or solvent-based mixture is preferably also nonflammable at room temperature.

The mixture may comprise additives such as surface-active substances, antifreeze agents, coagulating agents, cosolvents, emulsifiers or stabilizers, drying agents, catalysts and biocides against one or more microorganisms. Suitable additives are described in U.S. Ser. No. 11/124,918 B2. The proportion of additives is preferably 0.1 to 20 wt % of the total weight of the mixture. Drying agents and/or catalysts are important for water-based mixtures.

For preparing the mixture, the separate components may be added and mixed together, for example by means of a stirrer. The separate components may be dissolved beforehand in suitable solvents.

Application on the edges of the floor panel itself takes place for example in the first phase by means of a transfer technique wherein the liquid comprising the hydrophobic polymer is first applied on a wheel or roll and then is transferred by the wheel or roll onto the edge of the panel. This method of application is comparable to that described in WO 2006/038867. The solvent-based or water-based mixture may possibly be of low viscosity, so that it is not taken up easily by the wheel and easily runs off of the wheel back into the liquid reservoir.

To improve the foregoing, the aforementioned hydrophobic polymer may form part of a mixture that comprises at least one alkyd polymer and/or a resin and/or a polyurethane modified polyester, such as an alkyd resin and/or a (hydrogenated) resin from conifers and/or acrylate resin. The alkyd polymer may be a resin and is then for example an alkyd resin. The aforementioned alkyd polymer is preferably urethane or isocyanate modified. This alkyd resin may comprise a medium- or long-chain alkyd. The resin may for example be a hydrogenated resin from pine trees/fir trees. This resin, which mainly occurs in the solid state, may be dissolved beforehand, for example in isoparaffins or in a resin compatible with isoalkanes or isoparaffins, so as to facilitate adding the resin from pine trees/fir trees to the mixture. Preferably the alkyd polymer is dissolved in a nonaromatic solvent and this is added to form said mixture. This alkyd polymer may or may not be urethane or isocyanate modified to promote water resistance. The advantage is threefold: besides the price advantage the alkyd polymer/resin not only provides increased viscosity but, certainly in the case of a medium- or long-chain resin, penetration into the wood is less deep and it may provide a first barrier on account of its small degree of spreading. The (alkyd) resin forms an external film layer whereas said hydrophobic polymer rather provides impregnation protection. Since a relatively thin layer can be applied, the coating does not have to be dried to meet the existing environmental standards (AgbB etc.).

If the mixture, besides the aforesaid hydrophobic polymer, comprises said paraffin and comprises one or more polymers from the group of alkyd resins, acrylate resins, polyurethane modified polyesters, silanes and siloxanes, then the weight ratio of the sum of the weights of the hydrophobic polymer and the paraffin to the weight of the polymers from the aforementioned group is preferably between 10:90 and 90:10.

The alkyd polymer may be formulated in such a way that for example a preliminary reaction with ethoxy- or methoxysilane is induced so that after application no alcohol (for example such as methanol or ethanol) is separated further. As a result, the optional silane with a long alkyl chain will bond rather to the alkyd than to the OH groups of the wood surface and the alkyd can be made hydrophobic. The resin may for example comprise tall oil fatty acids, wherein the tall oil fatty acids, for example in combination with pentaerythritol, for example urethane modified pentaerythritol, are added to the mixture. The resin may for example also comprise urethane modified high-linoleic oils.

Besides transfer application, spray application may also be used. The advantage of said application is that a greater layer thickness can be achieved, which promotes water resistance. It is also possible to make use of a Vacuumat. The mixture may for example be applied on floor panels in such a way that in the dried state, 0.1 to 30 g/m², preferably 1 to 10 g/m² of the mixture is present.

It may also be selected to treat a said decorative panel twice with a said hydrophobic polymer or a said mixture comprising this hydrophobic polymer. It is thus possible to apply two coating layers or spray twice or carry out transfer printing twice.

Besides the amount applied, the following parameters are also important for achieving good water-repellent properties:
The squareness of the panels
The pretension between the panels, for example brought about on the basis of the technique that is known per se from WO97/47834, namely the technique wherein the contours of the coupling means on two opposite edges of the panel are configured as overlapping in such a way that in the coupled state a portion of the coupling is bent and, owing to its elastic recovery, presses the edges against each other. Preferably this is an elastic deflection of a groove lip, for example the lower groove lip, in a tongue-and-groove joint with locking elements.
The quality of milling with which the edges of the panels have been finished

In one embodiment, the aforementioned hydrophobic polymer forms part of a mixture that comprises at least one colorant and/or pigments, preferably a liquid colorant agent, or preferably at least one coloring agent that is free from solid pigments. Suitable colorants are added in order to conceal the white lines that arise during milling, for example of the melamine layers in the case of laminate panels. These colorants have no effect on the water resistance. For this purpose, preferably they do not consist of solid particles such as pigments, but rather of liquid colorant agents. The colorants and/or pigments may for example account for 1 to 10 wt % of the total weight of the mixture.

In a specific embodiment, the aforementioned hydrophobic polymer forms part of a mixture, wherein this mixture comprises at least one component that provides a color change when it comes into contact with the substrate on which the mixture is intended to be applied. For example, if the mixture is intended to be applied on MDF/HDF of for example a laminate panel, in order to provide at least water-resistant properties on surfaces of this MDF/HDF, the mixture may comprise a component that provides a color change if this component comes into contact with urea or comes into contact with some other constituent of this MDF/HDF. In a very specific embodiment, the MDF/HDF may also comprise an additional second component, which is provided to react with the first said component in such a way that a color change/alteration of color is visible. Thus, this second component may be added during the production of MDF/HDF or be applied on the edges of this MDF/HDF prior to application of the mixture. In this way, it is possible to check whether the mixture has been applied well.

In a specific embodiment, the aforementioned hydrophobic polymer forms part of a mixture, wherein this mixture comprises at least one component that fluoresces under UV light. The advantage here is that it is easy to check whether the mixture has been applied correctly.

In a specific embodiment, the aforementioned hydrophobic polymer forms part of a mixture that comprises at least one adhesion promoter, wherein this adhesion promoter is preferably silane-based.

The aforementioned hydrophobic polymer preferably forms part of a mixture, wherein the aforementioned hydrophobic polymer preferably forms part of this mixture between 3 and 40 wt %, even more preferably between 5 and 30 wt % and most preferably between 5 and 10 wt %. This relates to an ideal ratio for the components that contribute to the water repellency and the components, for example such as solvents or water, that contribute to good application on the decorative panel.

Preferably the aforementioned hydrophobic polymer forms part of a mixture, wherein this mixture preferably comprises one or more of the following characteristic features:
the mixture comprises, besides the hydrophobic polymer, between 5 and 10 wt % of said silicon-containing compounds as described above;
the mixture comprises between 3 and 20 wt % of alkyd polymer and/or resin, for example alkyd resin or a (hydrogenated) resin from conifers, as described above. Thus, the mixture may comprise between 15 and 20 wt % of hydrogenated resin from pine trees/fir trees,
the mixture comprises between 5 and 80 wt % of solvents or water;
the mixture comprises paraffin, for example paraffin wax;
the mixture comprises polytetrafluorethylene wax,
the mixture comprises at least one polymer selected from alkyd resins, acrylate resins, polyurethane modified polyesters, silanes, siloxanes or mixtures thereof;
the mixture comprises additives such as surface-active substances, antifreeze agents, coagulating agents, cosolvents, emulsifiers or stabilizers, drying agents, catalysts and biocides against one or more microorganisms.

Here, the mixture comprises for example the following components:
20 to 30 wt % of a component comprising a hydrophobic polymer, such as a hydrophobic polyurethane, dissolved in a solvent such as an acetate, wherein the hydrophobic polymer preferably accounts for between 20 and 30 wt % of the component;
5 to 10 wt % of silicon-containing compounds;
5 to 20 wt % of alkyd resin or 5 to 20 wt %. of (hydrogenated) resin from conifers;
5 to 20 wt % of the aforesaid cosolvents, such as 2-ethylacetate and/or methoxypropyl acetate and/or triethyl citrate;
supplemented with solvents to 100 wt %, for example such as hydrocarbons, for example white spirit.

When the use takes place on the edges, for example on the click joint, in other words on the mechanical coupling means, no UV degradation of the hydrophobic polymer or the mixture comprising the hydrophobic polymer can occur, which results in a long life.

Preferably, the use according to the present invention is applied on a decorative panel with a substrate with a decorative top layer applied thereon.

Preferably, the substrate consists substantially of an MDF or HDF board (medium or high density fiberboard), preferably with an average density of more than 800 kilograms per cubic meter. Preferably it relates to an HDF board of the type that has a locally higher density on both of its surfaces, a so-called peak density, which is at least 110% of the average density. It is clear that in such a case the HDF material located more centrally in the thickness has a density that is lower than the average density, and, for example, has less than 90% of this average density. Preferably, the aforementioned substrate has, on the substrate surface proper, a density of more than 900 kilograms per cubic meter. In the case of an HDF board with a peak density of at least 110% of the average density, a lower edge region preferably extends deeper than the zone with the aforementioned peak density, namely preferably into a zone that has a density that corresponds to the average density of the respective board, or less. The presence of the higher density near the surface of the substrate, preferably at least on that side of the substrate that is provided with the decorative top layer, leads to an increased resistance to the development of visible effects on the surface as a result of the penetration of moisture into the substrate. Thus, a zone of higher density will have a minimizing influence on possible swelling effects of the substrate material, which may lead to raised edges, and resultant accelerated wear of the top surface at the location of these edges.

Preferably, the decorative top layer is a laminate formed on the basis of melamine resin or some other thermosetting resin, and optionally one or more paper sheets. Preferably the laminate comprises at least one printed paper sheet provided with resin and preferably a transparent or translucent paper sheet provided with resin, applied on top of that. The laminate may further comprise wear-resistant particles located above the printing. Preferably the laminate is attached to the substrate material without additional intermediate glue or resin layers, namely both on the top surface proper and at the location of the lower edge region. The laminate preferably relates to a laminate of the DPL type (“Direct Pressure Laminate”) A particular aspect of a DPL technique is that the laminate layer is formed by the consolidating, by means of a pressing operation, of at least one decorative paper and one or more layers of synthetic material, whether or not provided on the decorative paper for example by means of an impregnation technique. The synthetic material relates herein to a thermal curing material, such as melamine resin. The consolidating involves at least one curing or crosslinking of the thermal curing synthetic material. At the same moment, namely based on one and the same pressing operation, this laminate layer is fastened to the substrate. In the commonest DPL panels, the laminate layer is assembled from a printed decorative paper provided with thermosetting resin and a transparent layer, which contains thermosetting resin, also called overlay, applied on top of that. On the underside of the substrate material, during the same pressing operation, preferably a resin layer is also provided, for example at least one resin-impregnated paper sheet. This serves as a balance layer for possible tensile stresses in the laminate layer on the top surface, so that a stable pressed whole can be achieved.

Other possibilities for the substrate are for example a thermoplastic substrate, for example based on PVC and fillers, or a mineral-based substrate, for example based on cement such as Portland cement or magnesium oxide (MgO), which may also comprise fillers. A thermoplastic substrate based on PVC and fillers may for example comprise a mineral filler, such as CaCO₃. Mineral fillers such as CaCO₃ can adhere very well to a said hydrophobic polymer, so as to bring about the bond between the hydrophobic polymer and the substrate.

Other possibilities for the decorative top layer are for example decorative top layers that comprise a printed plastic film, or that comprise a print formed directly on the substrate, or that comprise a layer of wood, such as a wood veneer.

Preferably the aforementioned panel is a floor panel, preferably of the type that may be used for forming a floating floor covering. According to the most preferred embodiment, the floor panel is a laminate floor panel with a substrate made of MDF or HDF and a decorative top layer made of laminate as described above. According to variants, the floor panel is an LVT, SPC or WPC floor panel, namely a floor panel with a thermoplastic substrate and a decorative top layer with a printed plastic film, or a print formed directly on the substrate, or with a layer of wood.

Preferably, the respective panels are provided, at least on two sides that extend transversely to each other, with coupling means with which two such panels can be coupled together.

According to the most preferred embodiment, the aforementioned panel is rectangular and elongated.

This use is applied for example for the manufacture of panels, more particularly floor panels, with an MDF or HDF substrate and a decorative top layer applied thereon from laminate, wherein the panel is provided on at least two opposite edges with a lower edge region in the top surface, wherein the aforementioned decorative top layer extends continuously from the top surface proper, over the surface of the lower edge region, and up to the edge of the top surface. Preferably, a panel obtained on the basis of this use has, at least on a pair of long edges, a lower edge region in the top surface, preferably in the form of a straight or curved chamfer. Preferably, it relates to a so-called pressed-in chamfer, namely a chamfer that is obtained during the same pressing operation with which the DPL laminate layer is produced on the surface of the substrate.

The aforementioned hydrophobic polymer preferably forms part of a mixture, wherein the mixture may for example comprise titanium-containing compounds. These titanium-containing compounds may account for between 0.1 and 5 wt %, for example between 0.1 and 2 wt %, of the mixture and improve the soap resistance and the hydrophobic properties of the mixture. Especially if the mixture is solvent-based, titanium-containing compounds are advantageous for promoting crosslinking of polyurethane. Examples of possible titanium-containing compounds are catalysts such as tetra-n-butyltitanate, and/or other titanates and/or titanium-containing silicone oligomers.

The aforementioned hydrophobic polymer preferably forms part of a mixture, wherein the mixture comprises for example catalysts based on other metals (tin-free catalysts) such as tin, zinc, iron or metal compounds, such as bismuth octoate. These tin-free catalysts may or may not be used in combination with titanium-containing compounds.

In the case of water-based or solvent-based mixtures, the drying of the alkyd may be promoted by using cobalt drying agents or cobalt-free drying agents based on zirconium or manganese or iron, whether or not in combination with other metals such as strontium.

A second aspect according to the invention relates to a decorative panel, for example such as a floor panel, comprising at least one surface covered with a coating or comprising one or more treated surfaces, wherein the coating or a said treated surface comprises a hydrophobic polymer with an aliphatic hydrocarbon group, preferably with 6 to 34 carbon atoms. Here, these surfaces have water-repellent and/or water-resistant properties.

Preferably, the hydrophobic polymer is derived by the use as described above. The hydrophobic polymer is thus a hydrophobic polymer as described above and preferably forms part of a mixture as described above, wherein this hydrophobic polymer or this mixture comprising this hydrophobic polymer, was applied on the decorative panel, in accordance with the use according to the first aspect of the invention, to form the decorative panel. All embodiments and advantages described above for the use, are thus all applicable to this decorative panel.

The following is a nonexhaustive list of possible additional properties of this decorative panel, wherein two or more properties may be combined, provided these are not incompatible with each other:
the aliphatic hydrocarbon group is a linear hydrocarbon chain;
the aliphatic hydrocarbon group is a branched hydrocarbon chain;
the aliphatic hydrocarbon group is a cyclo-aliphatic hydrocarbon group (alicyclic hydrocarbon group);
the hydrophobic polymer comprises one said aliphatic hydrocarbon group;
said aliphatic hydrocarbon group comprises at least 4 carbon atoms, preferably at least 12 carbon atoms, even more preferably at least 16 carbon atoms;
the hydrophobic polymer is built up from monomers comprising at least one said aliphatic hydrocarbon group and preferably comprising at least two said aliphatic hydrocarbon groups; the hydrophobic polymer is built up exclusively from monomers comprising at least one said aliphatic hydrocarbon group and preferably comprising at least two said aliphatic hydrocarbon groups;
the hydrophobic polymer is a homopolymer or a copolymer;
the hydrophobic polymer comprises two or more said aliphatic hydrocarbon groups, wherein these aliphatic hydrocarbon groups are all the same or these aliphatic hydrocarbon groups comprise two or more different aliphatic hydrocarbon groups, whether or not of different types, being for example the types of aliphatic linear hydrocarbon chains, branched hydrocarbon chains and cyclo-aliphatic hydrocarbon chains;
the hydrocarbon group comprises between 6 and 34 carbon atoms. Preferably the hydrocarbon group comprises at least 8 carbon atoms, even more preferably at least 10 carbon atoms, and most preferably at least 12 carbon atoms. Also preferably, the hydrocarbon group comprises at most 30 carbon atoms, even more preferably at most 28 carbon atoms, and most preferably at most 26 carbon atoms. Thus, the hydrocarbon group may comprise for example 12 carbon atoms, 16 carbon atoms, for example a hexadecyl group (C₁₆H₃₃), 18 carbon atoms, for example an octadecyl group (C₁₈H₃₇), or 22 carbon atoms;
the hydrophobic polymer is selected from the group comprising: a hydrophobic polyurethane, a hydrophobic acrylate, a hydrophobic vinyl acetate, a hydrophobic alkyd, a hydrophobic methacrylate, a hydrophobic polyester resin, a hydrophobic hybrid alkyd-acrylic resin, a hydrophobic hybrid polyurethane-acrylic resin, a hydrophobic polycarbodiimide or a hydrophobic polyvinyl alcohol;
the hydrophobic polymer is a hydrophobic polymer consisting of 3 to 10 units;
the aliphatic hydrocarbon group forms part of an acrylate group or a methacrylate group;
the hydrophobic polymer is a hydrophobic polyurethane comprising between 2 and 12 acrylate groups and/or methacrylate groups, wherein these acrylate groups and/or methacrylate groups each comprise aliphatic hydrocarbon groups, which are or are not different from each other and with preferably between 2 and 34 carbon atoms, wherein preferably at least one of these aliphatic hydrocarbon groups comprises at least 8 carbon atoms;
the hydrophobic polymer is free from fluorine atoms;
the hydrophobic polymer is a silicon-containing compound, such as a siloxane, a silicone or a silane, such as an organosilane, for example a silane comprising for example a hexadecyl group and/or an alkoxysilane;
the coating is applied on the lateral edges, or the lateral edges of the decorative panel form the treated surface,
the decorative panel comprises a substrate made of MDF, HDF, magnesium oxide (MgO), some other mineral-based substrate, a thermoplastic-based substrate, such as a PVC based substrate, wherein the coating is applied on this substrate or this substrate has been treated, for example the edges of the substrate;
the coating is applied on the top surface of a layer of wood, such as a veneer or a thicker layer of wood, or this top surface has been treated, wherein this layer of wood forms the decorative top layer of the decorative panel;
the hydrophobic polymer is a hydrophobic polyurethane preferably with the following formula:

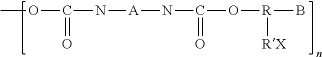

preferably with one or more of the following characteristics:
n is between 3 and 15, even more preferably between 3 and 10;
A is a residue of an isocyanate, for example a residue of a diisocyanate, such as methylene diphenyl diisocyanate, or of a triisocyanate or of a polyisocyanate, wherein this polyisocyanate is for example a reaction product of carbodiimide and an isocyanate;
R is a hydrocarbon group,
R′ is a hydrocarbon group, such as an alkene group;
X is a heteroatom or a hydrogen;
B comprises said aliphatic hydrocarbon group.

R may for example have one of the following formulas.

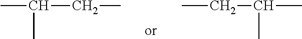

R′ may for example be a methylene group, an ethylene group, a propylene group or a butylene group

X may for example be an oxygen atom (O), a nitrogen group (NH) or a sulfur (S).

B may for example comprise the following formula:

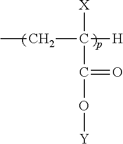

with X being CH₂, H, an acrylate or a methacrylate;
with p between for example 2 and 12;
with Y being said aliphatic hydrocarbon group, such as a linear aliphatic hydrocarbon chain with for example 12, 16, 18 or 22 carbon atoms.
the hydrophobic polymer is a hydrophobic acrylate polymer or a hydrophobic methacrylate polymer with the following formula.

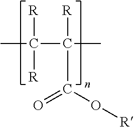

wherein the R groups are hydrocarbon groups or hydrogen atoms and the R′ group is a said aliphatic hydrocarbon group;
the hydrophobic polymer is a polycarbodiimide;
the coating or said treated surface comprises, besides the hydrophobic polymer, also silicon-containing compounds, wherein these silicon-containing compounds are preferably selected from the group: siloxanes, silicones, silanes, SiO₂-containing compounds, silylated polyurethanes and poly(silazanes). Here, the coating or said treated surface then comprises for example a non-silicon-containing hydrophobic polymer, such as a hydrophobic polyurethane, a hydrophobic acrylate, a hydrophobic vinyl acetate, a hydrophobic alkyd, a hydrophobic methacrylate, a hydrophobic polyester resin, a hydrophobic hybrid alkyd-acrylic resin or a hydrophobic hybrid polyurethane-acrylic resin, a hydrophobic polycarbodiimide and additionally a silicon-containing compound, wherein this silicon-containing compound preferably is also hydrophobic. This silicon-containing compound is for example hydrophobic because this compound also comprises a said aliphatic hydrocarbon group with 6 to 34 carbon atoms. Thus, the silicon-containing compound may for example be hexadecyl trimethoxysilane, or hexadecyl triethoxysilane or octadecyl triethoxysilane. The silanes may also be oligomers of the methoxylated type (methoxysilanes) or oligomers with ethoxy functional groups (ethoxysilanes);
the hydrophobic polymer is a silicon-containing compound;
the coating or said treated surface comprises a solvent, wherein this solvent for example comprises alkanes, such as iso-alkanes or aliphatic hydrocarbons.
the coating or said treated surface comprises one or more of the following components: ethylhexyl acetate, propyl acetate or butyl acetate—for example 3-Methoxy-3-Methyl-1-Butyl Acetate (MMB-AC) or 1-Methoxy-PropylAcetate (MPA)-, triethyl citrate, propylene glycol methyl ether, propylene glycol methyl ether acetate, dibasic ester, glycol diether, benzoate ester, dipropylene glycol dimethyl ether or tetramethoxy ether. These components may or may not be indicated as cosolvents.
the coating or said treated surface comprises an alkyd polymer, such as an alkyd resin, wherein the aforementioned alkyd polymer is preferably urethane or isocyanate modified. This alkyd resin may comprise a medium- or long-chain alkyd.
the coating or said treated surface comprises a colorant, preferably a liquid colorant agent, or at least a colorant agent that is free from solid pigments.

In a preferred embodiment, the decorative panel comprises at least two opposite lateral edges that comprise coupling parts, which allow two such panels to be coupled on the respective lateral edges, wherein in the coupled state, locking is present in a direction perpendicular to the plane of the coupled panels and/or in a direction in the plane of the panels and perpendicular to the coupled lateral edges and wherein at least said opposite lateral edges comprise a said coating or form said treated surfaces. The risk of water penetrating at the level of the coupled edges of decorative panels is in this case very small. Preferably the decorative panel comprises at least two pairs of opposite lateral edges that comprise coupling parts, which allow two such panels to be coupled on the respective lateral edges, wherein all these lateral edges comprise a said coating or form said treated surfaces.

In a specific embodiment, the decorative panel is a floor panel selected from the list consisting of:
floor panels with a substrate, wherein this substrate is or is not porous or moisture-absorbing, for example MDF, HDF, MgO, cement fiberboard, plasterboard, cork, thermoplastic substrates such as substrates based on PVC, PVB, PP, PE or PLA, foamed substrates, for example thermoplastic foamed substrates,
floor panels with a decorative top layer that comprise a print, wherein the decorative top layer is fastened directly or indirectly to an underlying substrate,
floor panels with a decorative top layer that comprises a wood veneer (thickness 2.5 mm) or a layer of wood (thickness from 2.5 mm), wherein an optional wood veneer preferably has a thickness from 0.4 to 0.8 mm, and
floor panels for the assembling of a floating floor covering, preferably with an MDF or HDF substrate, or with a thermoplastic substrate.

The invention relates according to a third aspect to a method for the manufacture of decorative panels, comprising the step of application of a coating or the treatment of at least one portion of a surface, such as one lateral edge, of the aforementioned panels, wherein for application of the aforementioned coating or the treatment of at least one portion of a surface of the aforementioned panels, use is made of a hydrophobic polymer, wherein this hydrophobic polymer is applied and wherein preferably the use of the hydrophobic polymer is defined as described in the first aspect of the invention. All described embodiments and advantages of the first aspect of the invention are thus applicable to this third aspect. By means of this method, in addition a decorative panel is obtained according to the second aspect of the invention. All embodiments and advantages of the second aspect are thus applicable to this third aspect.

In a preferred embodiment, this method is used for the manufacture of panels with at least two opposite lateral edges that comprise coupling parts, which allow two such panels to be coupled on the respective lateral edges, wherein in the coupled state, locking arises in a direction perpendicular to the plane of the coupled panels and/or in a direction in the plane of the panels and perpendicular to the coupled lateral edges.

In a specific embodiment, this method is used for the manufacture of decorative panels comprising a substrate and a layer of wood fastened to the substrate, and wherein this method comprises the step of application of a said coating with the hydrophobic polymer on the layer of wood or the treatment of at least the layer of wood with the one hydrophobic polymer. This layer of wood may be thinner than 2.5 mm and is then indicated with the term ‘veneer’. This layer of wood may also be thicker One or more layers of oil or varnish are or are not applied additionally on the layer of wood. Application of a said coating with the hydrophobic polymer on the layer of wood or the treatment of at least the layer of wood with the one hydrophobic polymer may take place before or after application of said one or more layers of oil or varnish.

In a specific embodiment, the aforementioned decorative panels are floor panels selected from the list consisting of:
floor panels with a substrate, wherein this substrate is or is not porous or moisture-absorbing, for example MDF, HDF, MgO, cement fiberboard, plasterboard, cork, thermoplastic substrates such as substrates based on PVC. PVB, PP, PE or PLA, foamed substrates, for example thermoplastic foamed substrates;
floor panels with a decorative top layer that comprise a print, wherein the decorative top layer is fastened directly or indirectly to an underlying substrate;
floor panels with a decorative top layer that comprises a wood veneer (thickness <2.5 mm) or a layer of wood (thickness from 2.5 mm), wherein an optional wood veneer preferably has a thickness from 0.4 to 0.8 mm, and;
floor panels for the assembling of a floating floor covering, preferably with an MDF or HDF substrate, or with a thermoplastic substrate.

A fourth aspect according to the invention relates to a mixture comprising a hydrophobic polymer, being for example a hydrophobic polycarbodiimide, a hydrophobic polyurethane or a hydrophobic acrylate polymer, wherein the hydrophobic polymer comprises an aliphatic hydrocarbon group preferably with 6 to 34 carbon atoms, and wherein the mixture additionally comprises one or more of the following characteristic features:
the aliphatic hydrocarbon group is selected from the group containing: linear hydrocarbon chains, branched hydrocarbon chains and alicyclic hydrocarbon groups;
the hydrophobic polymer forms part of the mixture between 3 and 40 wt %/o, preferably between 5 and 30 wt %;
the hydrophobic polymer is free from fluorine atoms;
the hydrophobic polymer is a hydrophobic polyurethane preferably with the following formula:

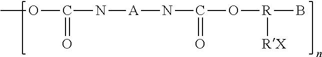

with more preferably one or more of the following characteristics:
   n is between 3 and 15, even more preferably between 3 and 10;
   A is a residue of an isocyanate, for example a residue of a diisocyanate, such as methylene diphenyl diisocyanate, or of a triisocyanate or of a polyisocyanate, wherein this polyisocyanate for example is a reaction product of carbodiimide and an isocyanate;
   R is a hydrocarbon group;
   R′ is a hydrocarbon group, such as an alkene group;
   X is a heteroatom or a hydrogen;
   B comprises said aliphatic hydrocarbon group.
the mixture comprises, besides the aforesaid hydrophobic polymer, silicon-containing compounds, wherein these silicon-containing compounds are preferably selected from the group: siloxanes, silicones, (organofunctional) silanes and SiO₂-containing compounds and wherein also preferably these silicon-containing compounds account for 5 to 10 wt %/o of the mixture. More preferably this mixture may comprise components that help to prevent unwanted hydrolysis of the silicon-containing compounds, such as an oxazolidine or polyacrylates. Thus, the mixture may for example comprise between 0.5 and 2 wt % of oxazolidine;
the mixture comprises a wetting agent, such as a long-chain alcohol or 3,5-dimethyl-1-hexyn-3-ol.
the mixture comprises solvents or the mixture comprises water as solvent, wherein the solvents or water preferably account for between 5 and 80 wt % of the mixture;
the mixture is a solvent-based mixture with a flash point of 35° C. or more, preferably of 55° C. or more;
the mixture is a solvent-based mixture comprising alkanes, for example iso-alkanes or aliphatic hydrocarbons, as solvent.
the mixture is a solvent-based mixture with one or more of the following components, ethylhexyl acetate, propyl acetate or butyl acetate—for example 3-Methoxy-3-Methyl-1-Butyl Acetate (M MB-AC) or 1-Methoxy-PropylAcetate (MPA)-, triethyl citrate, propylene glycol methyl ether, propylene glycol methyl ether acetate, dibasic ester, glycol diether, benzoate ester, or tetramethoxy ether.
the mixture comprises at least one alkyd polymer, wherein the aforementioned alkyd polymer is preferably urethane or isocyanate modified and wherein also preferably said alkyd polymer accounts for between 3 and 20 wt % of the mixture;
the mixture comprises titanium-containing compounds. These titanium-containing compounds may for example account for between 0.1 and 5 wt %, for example between 0.1 and 2 wt %, of the mixture and improve the soap resistance and the hydrophobic properties of the mixture. Especially if the mixture is solvent-based, titanium-containing compounds are advantageous. Examples of possible titanium-containing compounds are catalysts such as titanates—for example tetra-n-butyltitanate-, and/or titanium-containing silicone oligomers.
the mixture comprises catalysts based on other metals (tin-free catalysts) such as zinc, iron or metal compounds, such as bismuth octoate. These tin-free catalysts may or may not also be used in combination with titanium-containing compounds.
the mixture comprises cobalt drying agents or cobalt-free drying agents based on zirconium or manganese or iron, whether or not in combination with other metals such as strontium.

This mixture may be used here for realizing a coating or treatment on one or more surfaces of decorative panels. Here, this relates to a mixture that may be used as a mixture in the use presented in the first aspect of the invention. All embodiments and advantages relating to the mixture described in the first aspect are thus applicable to this fourth aspect.

The invention also relates to the following list of numbered items:
1. Use of a fluorine-free covering composition/coating composition, being a mixture, which comprises
a at least one polycarbodiimide compound, wherein the at least one polycarbodiimide compound comprises at least two hydrocarbon groups each with at least 4 carbon atoms, preferably at least 12 carbon atoms, even more preferably at least 16 carbon atoms, for the impregnating of floor coverings, such as floor panels—for example laminate floor panels, parquet floor panels, veneer parquet floor panels or plastic floor panels.
2. Use according to item 1, wherein the coating composition comprises
b. at least one paraffin wax.
3. Use according to item 2, wherein the weight ratio of paraffin wax to polycarbodiimide is 1:99 to 7:3, for example 1:20 to 1:10 or for example 3:7 to 7:3.
4. Use according to one of the preceding items, wherein the coating composition further comprises
c. at least one polymer selected from alkyd resins, acrylate resins, polyurethane modified polyesters, silanes, siloxanes or mixtures thereof.
5. Use according to item 4, wherein the weight ratio of (a+b) c is 10:90 to 90.10.
6. Use according to one of the preceding items, wherein the coating composition further comprises
d. at least one solvent.
7. Use according to item 6, with the characteristic feature that the selected solvent comprises water.
8. Fluorine-free coating composition/covering composition comprising
a. at least one polymer selected from alkyd resins, acrylate resins, polyurethane modified polyesters, silanes, siloxanes or mixtures thereof, and
b. at least one polycarbodiimide compound, wherein the at least one polycarbodiimide compound has at least two hydrocarbon groups each with at least 4 carbon atoms.
9. Fluorine-free coating composition according to item 8, wherein the composition comprises at least one paraffin wax.
10. Coating composition according to item 8 or 9, wherein at least one solvent is present
11. Floor covering covered with a fluorine-free coating composition according to one of the items 8 to 10.

With a “fluorine-free coating composition/covering composition” it is indicated here that no fluorine atoms are present. However, variants wherein a small amount of fluorine atoms is still present, are also possible. Then, for example less than 1 percent by weight (1 wt/o) of fluorine atoms are present in the coating composition/covering composition, preferably less than 0.5 wt %, more preferably less than 0.1 wt %/o or even less than 0.01 wt %. Fluorine may be in the form of organic or inorganic fluorine-containing compounds.

This coating composition/covering composition is preferably a mixture such as defined in the first aspect of the invention and may thus comprise one or more properties defined in the first aspect.

For better illustration of the features of the invention, some preferred embodiments are described hereunder, as examples without any limiting character, referring to the appended drawings, in which:

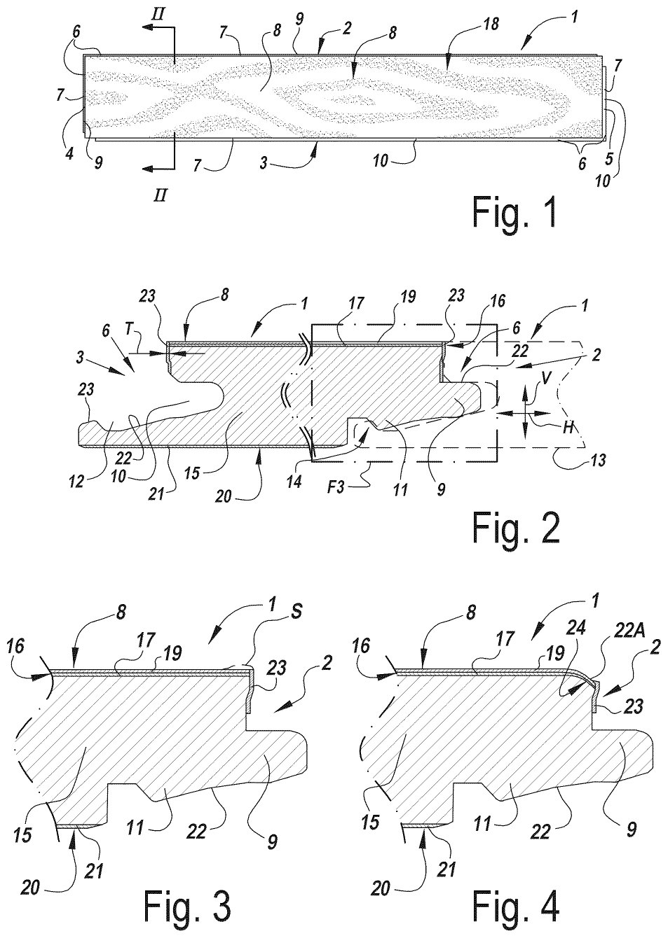

FIG. 1 is a floor panel, obtained on the basis of the use and a method according to the invention, according to a first embodiment;

FIG. 2 shows this floor panel in a cross section according to the line II-II in FIG. 1;

FIG. 3 shows, on a larger scale, the region that is indicated with F3 in FIG. 2; according to a somewhat divergent variant;

FIG. 4 shows a similar view to that in FIG. 3, of a second variant of the first embodiment,

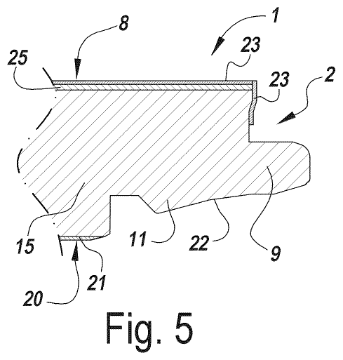

FIG. 5 shows a similar view to that in FIG. 3, of a third variant of the first embodiment.

FIG. 1 shows an elongated rectangular floor panel 1 that is provided on two pairs of opposite lateral edges, 2-3 and 4-5, with profiled edge regions 6 that comprise mechanical coupling parts 7.

FIG. 2 makes it clear that the coupling parts 7 used allow mutual locking of two such floor panels 1 both in a horizontal direction H and in a vertical direction V. For the purpose of locking in the vertical direction V, this is in a direction perpendicular to the upper side 8 of the floor panel 1, the coupling parts 7 shown here are configured substantially in the form of a tongue 9 and a groove 10. The locking in the horizontal direction H, i.e. in a direction perpendicular to the aforementioned vertical direction V and in the plane of FIG. 2, is in this case obtained by providing locking elements in the form of a projection 11 on the underside of the tongue 9 and a recess 12 in the lower lip of the groove 10. During coupling of two such floor panels 1, the locking elements 11-12 interact and they prevent the floor panels 1 moving apart. This is illustrated by showing the floor panel 1 with the dashed line 13, wherein it is clearly visible that an overlap 14 may exist between the uncoupled contours of the groove 10 and the tongue 9, more particularly between the contour of the respective locking elements 11-12. Based on this overlap 14, when coupling two floor panels a so-called pretension may be achieved. The concept of pretension is known per se from WO 97/47834. Preferably the mechanical coupling parts 7 used result in a clearance-free locking of two such floor panels 1 in the aforementioned horizontal direction H and vertical direction V and better still the coupling parts 7 result in a clearance-free locking in all directions in the plane defined by the aforementioned directions V and H.

It is clear that the floor panels 1 obtained in the context of the invention may have any shape, such as a rectangular, square, hexagonal shape or the like, and may also be provided with any coupling parts 7.

According to the first embodiment, the floor panel 1 relates to a laminate floor panel 1 that contains a substrate 15, wherein this substrate 15 consists wholly of a wood-based material such as MDF or HDF. In addition, the aforementioned coupling parts 7 are made in one piece with this substrate 15. Furthermore, the floor panel 1 contains a decorative top layer 16 based on plastic. In this case the decorative top layer 16 relates to a so-called “DPL” layer, which in this example consists of a decorative layer 17 with a printed pattern 18 and a wear-resistant layer 19 applied thereon, such as a so-called overlay. Both the decorative layer 17 and the overlay 19 comprise a resin-impregnated layer of paper. Moreover, the overlay 19 further comprises wear-resistant particles such as corundum. On its underside 20, the floor panel 1 has a balance layer 21, which also comprises a resin-impregnated layer of paper.

At least one portion of the surface 22 of the profiled edge regions 6 is provided with a coating 23 in which use is made of a hydrophobic polymer according to the invention. Alternatively, at least one portion of the surface 22 of the profiled edge regions 6 may be treated with a hydrophobic polymer according to the invention. The hydrophobic polymer is for example a hydrophobic polyurethane with a formula such as shown above. This coating 23 preferably comprises said hydrophobic polyurethane and a hydrophobic silicon-containing compound with an aliphatic hydrocarbon group with between 6 and 34 carbon atoms, for example such as hexadecyl trimethoxysilane or hexadecyl triethoxysilane or octadecyl triethoxysilane. Said coating 23 is not only water-repellent, but also soap-resistant.

In FIG. 2 it is shown that the coating 23 or treatment forms a layer or film with a certain thickness T. In this figure as well as in FIGS. 3 to 5 discussed hereunder, this layer is shown schematically as a layer that lies on top of the surface 22 of the profiled edge regions 6. It is clear that this layer in actual fact may have penetrated to a lesser or greater extent or even completely into the surface 22 of the relevant edge region 6. It is clear that it will preferably be ensured that the thickness T of the layer on top of the surface 22 is limited to a minimum thickness T, for example by employing a suitable dilution, for example by using sufficient solvent, so that the coating 23 or treatment is absorbed better in the substrate 15. Accordingly, it does not form any great impediment when coupling the respective edges 2-3 to a similar floor panel 1. Note that the thickness T of the film is shown exaggerated. In reality the thickness T may be in the micron range or may be nonexistent.

FIG. 3 shows a variant wherein the coating 23 covers the transition between the substrate 15 and the decorative top layer 16 as well as a limited strip under the upper edge of the floor panel 1. The use of said hydrophobic polymer, according to the present invention, in a strip-shaped coating 23 is very useful for conventional laminate floor panels 1 or other floor panels 1 that are not specifically intended for use in damp rooms. With conventional laminate floor panels 1, there is now the drawback that when cleaning with a damp cloth, moisture is taken up in the substrate 15, so that this swells and the laminate top layer is forced permanently upward near the edges of the floor panels 1. Because now, by means of among other things the hydrophobic polymer, an especially efficient seal may be produced, it is impossible for moisture to penetrate immediately under the laminate top layer and into the substrate 15, so that the aforementioned effect is excluded, or at least minimized.

It is shown with the dashed line S in FIG. 3 that the coating 23 can even continue onto the top surface 8 of the floor panel 1. In general, the aim is that the coating 23 at least covers the transition between the substrate 15 and the top layer 16.

FIG. 4 shows a variant wherein the profiled edge regions 6 compare at least one surface 22A that is configured as a lower edge region 24 or chamfer, in this case a bevelled edge. As shown, the coating 23 may also be provided on the surface 22A of this lower edge region 24. In the example shown, the decorative top layer 16 extends from the top surface 8 of the floor panel 1 continuously over the surface 22A of the lower edge region 24.

It is clear that in the examples in FIGS. 2 to 5, the groove side 3-5 (not shown) of the floor panel 1 has preferably undergone a similar treatment.

In general, it should further be noted that optionally indicating means may be incorporated in the coating 23 so as to be able to check whether this has been applied so that it covers the desired surface. These indicating means may consist of a colorant or a substance that for example fluoresces when irradiated with light or the like.

FIG. 5 shows a variant wherein the floor panel 1 contains a substrate 15, wherein this substrate 15 consists wholly of a wood-based material such as MDF or HDF. The floor panel 1 further comprises a decorative layer of wood 25. When the layer of wood 25 is thicker than 2.5 mm it is called parquet, and a thinner layer of wood 25 is called veneer parquet. The top surface 8 of the layer of wood 25 is provided with a coating 23 in which use is made of a hydrophobic polymer according to the invention and this coating 23 preferably covers (as shown in FIG. 5) additionally a portion of the surface 22 of the profiled edge regions 6. Alternatively, said surfaces 22 may be treated with a hydrophobic polymer according to the invention. The hydrophobic polymer is for example a hydrophobic polyurethane with a formula such as shown above. Preferably the coating 23 comprises said hydrophobic polyurethane and a hydrophobic silicon-containing compound. Said coating 23 is not only water-repellent, but also soap-resistant.

It is shown in FIG. 5 that the coating 23 forms a layer or film with a certain thickness T. This layer is shown schematically. It is clear that this layer in actual fact may have penetrated to a lesser or greater extent or even completely. It is clear that it will preferably be ensured that the thickness T of the layer is minimal. Note that the thickness T is shown exaggerated. In reality the thickness T may be in the micron range or may be nonexistent.

In order to apply said coating 23 as shown in the figures, preferably use is made of a mixture with the following properties:
20 to 30 wt % of a component comprising a hydrophobic polyurethane dissolved in a solvent such as an acetate and/or a hydrophobic polycarbodiimide dissolved in water or solvent, wherein the hydrophobic polyurethane accounts for between 20 and 30 wt % of the component. The hydrophobic polyurethane is preferably a polyurethane according to a formula as shown above wherein this polyurethane comprises at least one aliphatic linear hydrocarbon chain with at least 8 carbon atoms;
5 to 10 wt % of silicon-containing compounds;
5 to 20 wt % of alkyd resin or 5 to 20 wt % of (hydrogenated) resin from conifers or 5 to 20 wt % of a combination of tall oil fatty acids and urethane modified pentaerythritol;
5 to 20 wt % of said cosolvents selected from the group comprising: 2-ethylacetate and/or methoxypropyl acetate and/or triethyl citrate;
0.5 to 2 wt % of titanium-containing compounds, such as tetra-n-butyltitanate or a titanium-containing silicone oligomer;
optionally paraffin wax;
supplemented with solvents or water to 100 wt %, preferably supplemented with hydrocarbons, for example white spirit or supplemented with water to 100 wt %.

Some examples of tests that were carried out are given below.

### Examples

MDF/HDF laminate panels were treated with mixtures according to the invention. In order to determine the quality of impregnation and/or coating, the contact angle and the swelling at the edge were determined.

### Measurement of Contact Angle

Edges of MDF/HDF laminate panels are treated with a mixture according to the invention using a brush and then are held at room temperature for 24 h so that the laminate panels are completely dry. Then drops of water (0.2 ml to 0.3 ml) were placed on the treated edge by means of a contact angle meter (OK 15E10);

### Measurement of Contact Angle

<90′ hydrophilic
>90° to 130°: hydrophobic
>130°: superhydrophobic

### Edge Swelling

Edges of MDF/HDF laminate panels with tongue and groove are treated with a mixture according to the invention using a brush and then held at room temperature for 24 h so that the laminate panels are completely dry. The edge thicknesses of the laminate panels are measured at various points with a thickness gauge. 2 to 5 g/m² of the mixture was applied (weight as dried). Then the laminate panels are joined together by means of their tongue and groove and a wet cloth is applied on the floor obtained for 12 hours. Then new thickness measurements are taken at said points.

### Visual Assessment

1 very strong swelling
2 strong swelling
3 slight swelling
4 barely visible swelling
5 no swelling
by means of a thickness gauge (Kafer FD50), the thickness may be at most 0.1 mm

### Examples

TABLE 1
Water-based mixtures (in wt %)

| | Compar- | Mixture | Mixture |
|---|---|---|---|
| | ative | according to the | according to the |
| | example 1 | invention 1 | invention 2 |
| hydrophobic | 0.25 | 6 | 6 |
| polycarbodiimide + | | | |
| paraffin wax | | | |
| silane | 2 | 5 | 10 |
| polyurethane modified | 4 | 10 | 20 |
| polyester | | | |
| Organic solvent | — | — | — |
| Water | 91.75 | 69 | 54 |
| Additive as described | 2 | 10 | 10 |
| in U.S. Pat. No. | | | |
| 11,124,918 B2 | | | |

TABLE 2
Determination of the effect of the water-based mixtures

| | Comparative | Mixture according | Mixture according |
|---|---|---|---|
| | example 1 | to the invention 1 | to the invention 2 |
| Contact angle | 85° | 120° | 125° |
| Swelling, mm | 0.5 | 0.1 | 0.1 |
| Visual | 2 | 5 | 5 |
| assessment | | | |

TABLE 3
Solvent-based mixture (in wt %)

| | Compar- | Mixture | Mixture |
|---|---|---|---|
| | ative | according to the | according to the |
| | example 2 | invention 3 | invention 4 |
| Hydrophobic | 0.25 | 5 | 7.5 |
| polycarbodiimide + | | | |
| paraffin wax | | | |
| Silane | 3 | 5 | 2.5 |
| Alkyd resin | 1.8 | 9 | 9 |
| Organic solvent | 94.95 | 76 | 71 |
| Water | — | — | — |
| Additive as described | 2 | 5 | 10 |
| in U.S. Pat. No. | | | |
| 11,124,918 B2 | | | |

TABLE 4
Determination of the effect of the solvent-based mixtures

| | Comparative | Mixture according | Mixture according |
|---|---|---|---|
| | example 2 | to the invention 3 | to the invention 4 |
| Contact angle | 70° | 110° | 127° |
| Swelling, mm | 0.6 | 0.1 | 0.1 |
| Visual | 1 | 4-5 | 5 |
| assessment | | | |

The mixtures according to the invention 1 to 4 are found to have a strong hydrophobic action on laminate edges and hardly any swelling occurs as a result of contact with water.

Additional examples of possible compositions of mixtures according to the invention are shown below.

### Example of a Water-Based Mixture:

| | |
|---|---|
| Water | 45% |
| Polyurethane modified alkyd emulsion | 40% |
| Organic polysilazane | 5% |
| Additives as described in U.S. Pat. No. 11,124,918 B2 | 10% |

### Example of a Solvent-Based Mixture:

| | |
|---|---|
| Organic solvent | 37% |
| Alkyd resin | 25% |
| Urethane polymer | 30% |
| Titanate | 3% |
| Additives as described in U.S. Pat. No. 11,124,918 B2 | 5% |

The amounts are in percentages by weight. Possible additives are presented in U.S. Pat. No. 11,124,918B2. The additives are for example selected from surface-active substances, antifreeze agents, coagulating agents, cosolvents, emulsifiers or stabilizers, drying agents, catalysts and biocides against one or more microorganisms.

The present invention is by no means limited to the embodiments described above, and similar use or similar methods for the manufacture of panels 1 may be realized while remaining within the scope of the present invention.

1.-44. (canceled)

45. A mixture for producing a coating or treatment on one or more surfaces of decorative panels, wherein the mixture comprises a hydrophobic polymer,
wherein the hydrophobic polymer comprises an aliphatic hydrocarbon group with 6 to 34 carbon atoms.

46. The mixture in accordance with claim 45, wherein the hydrophobic polymer is selected from the list of: a hydrophobic polycarbodiimide, a hydrophobic polyurethane or a hydrophobic acrylate polymer.

47. The mixture in accordance with claim 45, wherein the aliphatic hydrocarbon group is selected from the group containing: linear hydrocarbon chains, branched hydrocarbon chains and alicyclic hydrocarbon chains.

48. The mixture in accordance with claim 45, wherein the hydrophobic polymer forms part of the mixture between 3 and 40 wt %.

49. The mixture in accordance with claim 45, wherein a said hydrophobic polymer is a polycarbodiimide with the following formula: 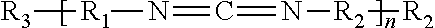
wherein at least one of the groups R₃ or R₄ comprises a said aliphatic carbon group, wherein R₃ and R₄ are or are not identical, and wherein n is an integer of at least 2, and
wherein R₁ and R₂ are residual groups derived from the carbodiimidization reaction, for example residual groups of isocyanates, such as methylene diphenyl diisocyanates.

50. The mixture in accordance with claim 45, wherein a said hydrophobic polymer is a hydrophobic polyurethane with the following formula: 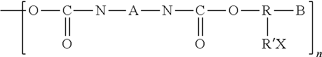
with one or more of the following characteristics:
n is between 3 and 15;
A is a residue of an isocyanate, for example a residue of a diisocyanate, such as methylene diphenyl diisocyanate, or of a triisocyanate or of a polyisocyanate;
R is a hydrocarbon group;
R′ is a hydrocarbon group, such as an alkene group;
X is a heteroatom or a hydrogen;
B comprises said aliphatic hydrocarbon group.

51. The mixture in accordance with claim 45, wherein the mixture comprises, besides a said hydrophobic polymer, silicon-containing compounds.

52. The mixture in accordance with claim 51, wherein these silicon-containing compounds are selected from the group: siloxanes, silicones and SiO₂-containing compounds.

53. The mixture in accordance with claim 45, wherein the mixture comprises a paraffin, for example a paraffin wax.

54. The mixture in accordance with claim 45, wherein the mixture comprises solvents or the mixture comprises water as solvent,
wherein the solvents or water account for between 5 and 80 wt % of the mixture.

55. The mixture in accordance with claim 45, wherein the mixture is a solvent-based mixture with a flash point of 55° C. or more.

56. The mixture in accordance with claim 45, wherein the mixture is a solvent-based mixture comprising alkanes, for example iso-alkanes or aliphatic hydrocarbons.

57. The mixture in accordance with claim 45, wherein the mixture is a solvent-based mixture with one or more of the following components: ethylhexyl acetate, propyl acetate or butyl acetate—for example 3-Methoxy-3-Methyl-1-ButylAcetate (MMB-AC) or 1-Methoxy-PropylAcetate (MPA)-, triethyl citrate, propylene glycol methyl ether, propylene glycol methyl ether acetate, dibasic ester, glycol diether, benzoate ester, or tetramethoxy ether.

58. The mixture in accordance with claim 45, wherein the mixture comprises at least one alkyd polymer and/or a resin.

59. The mixture in accordance with claim 45, wherein the mixture comprises an alkyd polymer which is urethane or isocyanate modified.

60. The mixture in accordance with claim 45, wherein the hydrophobic polymer is a hydrophobic acrylate polymer or a hydrophobic methacrylate polymer with the following formula: 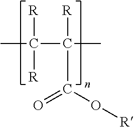
wherein the R groups are hydrocarbon groups or hydrogen atoms and the R′ group is a said aliphatic hydrocarbon group.

61. The mixture in accordance with claim 45, wherein the mixture comprises at least one wetting agent, or a surface tension lowering agent.

62. The mixture in accordance with claim 45, wherein the mixture comprises at least one colorant.

63. A decorative panel, such as a floor panel, comprising at least one surface covered with a coating or comprising one or more treated surfaces,
wherein the coating or a said treated surface comprises a hydrophobic polymer with an aliphatic hydrocarbon group with between 6 and 34 carbon atoms.

64. The decorative panel in accordance with claim 63, wherein the decorative panel is a floor panel selected from the list consisting of:
floor panels with a substrate, wherein this substrate is or is not porous or moisture-absorbing, for example MDF, HDF, MgO, cement fiberboard, plasterboard, cork, thermoplastic substrates, such as substrates based on PVC, PVB, PP, PE or PLA, foamed substrates, for example thermoplastic foamed substrates;
floor panels with a decorative top layer that comprise a print, wherein the decorative top layer is fastened directly or indirectly to an underlying substrate;
floor panels with a decorative top layer that comprises a wood veneer (thickness <2.5 mm) or a layer of wood (thickness from 2.5 mm), and;
floor panels for the assembling of a floating floor covering.
